(19) United States
(12) Patent Application Publication
(10) Pub. No.: US 2026/0001544 A1
(43) Pub. Date: Jan. 1, 2026

(54) VEHICLE CONTROL APPARATUS AND PROGRAM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Takahiro NARITA, Tokyo (JP); Riku KOYAMA, Tokyo (JP); Hirofumi MORI, Hadano-shi (JP); Yamato YORIFUJI, Nagakute-shi (JP); Toshinori OKITA, Gotenba-shi (JP)

(21) Appl. No.: 19/249,908

(22) Filed: Jun. 25, 2025

(30) Foreign Application Priority Data
Jun. 28, 2024 (JP) 2024-105622

(51) Int. Cl. B60W 30/16; B60W 50/08

(52) U.S. Cl. CPC B60W 30/16; B60W 50/085; B60W 2520/105; B60W 2540/10; B60W 2554/4041; B60W 2554/4042; B60W 2556/40; B60W 2720/106; B60W 2754/30

(57) ABSTRACT

A vehicle control apparatus is capable of performing deceleration control in which an own vehicle is decelerated based on road conditions ahead of the own vehicle in a travelling direction using map information. The vehicle control apparatus includes an accelerator operation determination unit and a deceleration control unit. The accelerator operation determination unit determines whether a driver of the own vehicle is operating an accelerator during execution of deceleration control. The deceleration control unit cancels the deceleration control based on travel information of at least either of the own vehicle and another vehicle traveling in a same direction as the own vehicle in a vicinity of the own vehicle, in response to the accelerator operation determination unit determining that the driver is operating the accelerator during execution of the deceleration control.

### CROSS-REFERENCE TO RELATED APPLICATIONS

This application is based on and claims the benefit of priority from Japanese Patent Application No. 2024-105622, filed on Jun. 28, 2024. The entire disclosure of the above application is incorporated herein by reference.

### BACKGROUND

### Technical Field

The present disclosure relates to a vehicle control apparatus and a program.

### Related Art

As vehicle control for providing travel assistance to a vehicle, a technology in which an own vehicle is caused to travel such as to track a preceding vehicle traveling ahead of the own vehicle is known. In addition, a technology in which an own vehicle position is ascertained using a global positioning system (GPS) or the like, and deceleration control of the own vehicle is performed based on the own vehicle position and map information is also known. For example, in a case in which a road on which the own vehicle is traveling is recognized to be a curved road ahead of the own vehicle in the travelling direction, an entry to an intersection ahead of the own vehicle in the travelling direction, or the like based on the map information, deceleration control in which brakes are operated automatically, rather than by a driver, is performed.

### SUMMARY

An aspect of the present disclosure provides a vehicle control apparatus that is capable of performing deceleration control in which an own vehicle is decelerated based on road conditions ahead of the own vehicle in a travelling direction using map information. The vehicle control apparatus includes: an accelerator operation determination unit that determines whether a driver of the own vehicle is operating an accelerator during execution of deceleration control; and a deceleration control unit that cancels the deceleration control based on travel information of at least either of the own vehicle and another vehicle traveling in a same direction as the own vehicle in a vicinity of the own vehicle, in response to the accelerator operation determination unit determining that the driver is operating the accelerator during execution of the deceleration control.

### BRIEF DESCRIPTION OF THE DRAWINGS

In the accompanying drawings:

FIG. 1 is a configuration diagram of an overview of a travel assistance system for a vehicle;

FIG. 2 is a diagram of an example of a travel scene of an own vehicle;

FIG. 3 is a timing chart for explaining deceleration control;

FIG. 4 is a timing chart for explaining deceleration control;

FIG. 5 is a flowchart of processing steps for deceleration control;

FIG. 6 is a flowchart of processing steps for deceleration control according to a second embodiment;

FIG. 7 is a diagram of an example of a travel scene of an own vehicle;

FIG. 8 is a flowchart of processing steps for deceleration control according to a third embodiment;

FIG. 9 is a diagram of an example of a travel scene of an own vehicle;

FIG. 10 is a flowchart of steps in a threshold setting process according to a fourth embodiment;

FIG. 11 is a diagram of a relationship between own vehicle acceleration and a reduction correction value K;

FIG. 12 is a flowchart of steps in a threshold setting process; and

FIG. 13 is a flowchart of steps in a threshold setting process.

### DESCRIPTION OF THE EMBODIMENTS

In a technology described in JP 2016-147506 A, for example, when an own vehicle enters a curve, deceleration control of the own vehicle is performed based on information on a curvature of the curve and a gradient included in map information. Furthermore, when a driver operates an accelerator during the deceleration control, the deceleration control is immediately stopped.

Here, in the configuration in which the deceleration control is stopped by the driver operating the accelerator as described above, the deceleration control may be unintentionally stopped if the driver erroneously operates the accelerator during execution of the deceleration control. In this case, unwanted acceleration of the own vehicle occurring in accompaniment with the stopping of the deceleration control becomes a concern. Meanwhile, the deceleration control may be needlessly performed in cases in which an error has occurred in the map information. In this case, it is thought that there is still room for technical improvement to appropriately stop the deceleration control while reflecting the intentions of the driver.

It is thus desired to provide a vehicle control apparatus and a program enabling vehicle deceleration control based on map information to be appropriately performed.

A first exemplary embodiment of the present disclosure provides a vehicle control apparatus that is capable of performing deceleration control in which an own vehicle is decelerated based on road conditions ahead of the own vehicle in a travelling direction using map information. The vehicle control apparatus includes: an accelerator operation determination unit that determines whether a driver of the own vehicle is operating an accelerator during execution of deceleration control; and a deceleration control unit that cancels the deceleration control based on travel information of at least either of the own vehicle and another vehicle traveling in a same direction as the own vehicle in a vicinity of the own vehicle, in response to the accelerator operation determination unit determining that the driver is operating the accelerator during execution of the deceleration control.

A second exemplary embodiment of the present disclosure provides a non-transitory computer-readable storage medium storing therein a program enabling a computer to perform deceleration control in which an own vehicle is decelerated based on road conditions ahead of the own vehicle in a travelling direction using map information, the program causing the computer to perform processes comprising: an accelerator operation determination process for determining whether a driver of the own vehicle is operating an accelerator during execution of deceleration control; and a deceleration control process for canceling the deceleration control based on travel information of at least either of the own vehicle and another vehicle traveling in a same direction as the own vehicle in a vicinity of the own vehicle, in response to the accelerator operation determination process determining that the driver is operating the accelerator during the execution of deceleration control.

A third exemplary embodiment of the present disclosure provides a vehicle control apparatus comprising: a processor; a non-transitory computer-readable storage medium; and a set of computer-executable instructions stored on the computer-readable storage medium that, when read and executed by the processor, cause the processor to implement: determining whether a driver of the own vehicle is operating an accelerator during execution of deceleration control; and canceling the deceleration control based on travel information of at least either of the own vehicle and another vehicle traveling in a same direction as the own vehicle in a vicinity of the own vehicle, in response to the accelerator operation determination process determining that the driver is operating the accelerator during the execution of deceleration control.

A fourth aspect of the present disclosure provides a vehicle control method capable of performing deceleration control in which an own vehicle is decelerated based on road conditions ahead of the own vehicle in a travelling direction using map information, the vehicle control method comprising: determining whether a driver of the own vehicle is operating an accelerator during execution of deceleration control; and canceling the deceleration control based on travel information of at least either of the own vehicle and another vehicle traveling in a same direction as the own vehicle in a vicinity of the own vehicle, in response to determining that the driver is operating the accelerator during execution of the deceleration control.

In a case in which a road on which the own vehicle is traveling is ascertained to be a curved road, a T-shaped intersection, a roundabout, or the like ahead of the own vehicle in the travelling direction, based on the map information, the own vehicle is decelerated by the deceleration control. In addition, the deceleration control is canceled based on the driver operating the accelerator during the execution of deceleration control based on the map information. However, in a case in which the accelerator is erroneously operated, occurrence of unintentional acceleration and the like of the vehicle immediately after cancellation of the deceleration control becomes a concern. In this regard, in the configuration described above, when the driver operates the accelerator during the execution of deceleration control based on the map information, the deceleration control is canceled based on the travel information of at least either of the own vehicle and another vehicle traveling in the same direction as the own vehicle in the vicinity of the own vehicle. In this case, based on the travel information of at least either of the own vehicle and the other vehicle traveling in the same direction as the own vehicle in the vicinity of the own vehicle, whether the accelerator is erroneously operated during the deceleration control based on the map information or the deceleration control is performed based on erroneous map information can be determined. As a result, the deceleration control can be appropriately canceled upon accurate determination of whether the accelerator operation by the driver is valid or invalid. Consequently, vehicle deceleration control based on the map information can be appropriately performed.

### First Embodiment

An embodiment implementing a vehicle control apparatus of the present disclosure will hereinafter be described with reference to the drawings. According to the present embodiment, for example, a travel assistance system that provides travel assistance to a vehicle such as a passenger vehicle, a truck, or a bus is constructed.

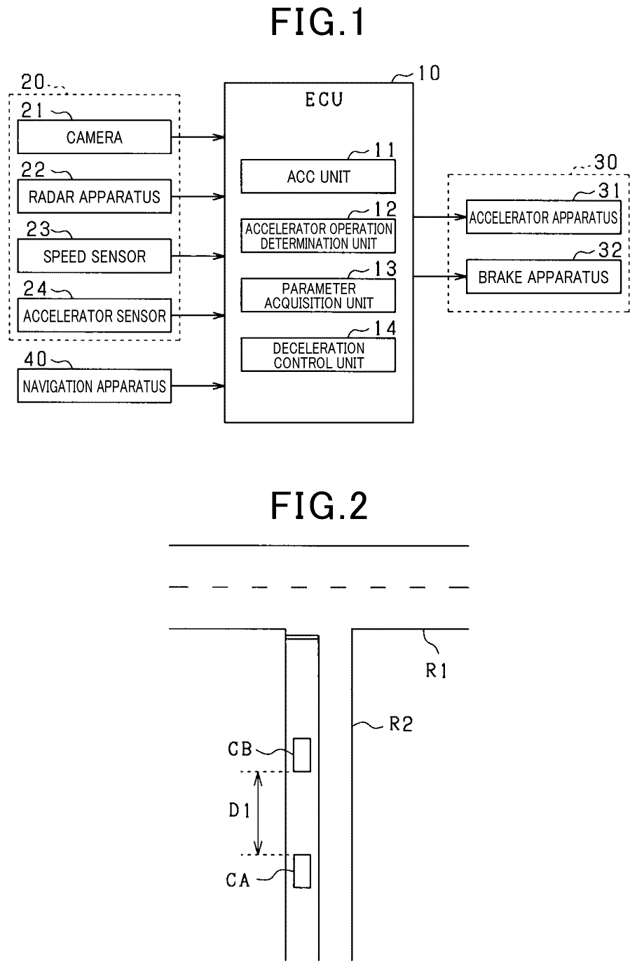

As shown in FIG. 1, the travel assistance system according to the present embodiment includes an electronic control unit (ECU) 10 serving as a vehicle control apparatus, sensors 20, a controlled apparatus 30, and a navigation apparatus 40. The sensors 20 include a camera 21, a radar apparatus 22, a speed sensor 23, and an accelerator sensor 24. The controlled apparatus 30 includes an accelerator apparatus 31 and a brake apparatus 32.

For example, the camera 21 may be a monocular camera. The camera 21 may be, for example, attached to each of a front end, a rear end, and left and right side surfaces of an own vehicle, and captures images of an own vehicle vicinity. The camera 21 transmits the captured images to the ECU 10 at a predetermined cycle. Here, the camera 21 may be a stereo camera.

The radar apparatus 22 is a distance measurement apparatus using millimeter-wave, high-frequency signals as transmission waves. For example, the radar apparatus 22 may be mounted on each of the front end, the rear end, and the left and right side surfaces of the own vehicle, and measures a distance to an object present in the own vehicle vicinity. Specifically, the radar apparatus 22 transmits a probe wave at a predetermined cycle, receives a reflected wave through a plurality of antennas, and measures the distance to the object based on a transmission time of the probe wave and a reception time of the reflected wave. In addition, the radar apparatus 22 calculates an orientation of the object from a phase difference between the reflected waves received by the plurality of antennas. As a result of the distance to the object and the orientation of the object being calculated, a relative position of the object to the own vehicle can be identified.

The speed sensor 23 detects a travel speed of the own vehicle. For example, a wheel speed sensor that detects a rotation speed of a wheel can be used as the speed sensor 23. The accelerator sensor 24 detects operation of the accelerator in the own vehicle by the driver. For example, when a depression operation amount of an accelerator pedal reaches a predetermined amount or greater, the accelerator sensor 24 may output an electrical signal indicating that the accelerator has been operated. Here, the accelerator sensor 24 may detect a magnitude of an accelerator operation amount.

The ECU 10 is an electronic control apparatus that includes a known microcomputer composed of a central processing unit (CPU), a read-only memory (ROM), a random access memory (RAM), a flash memory, and the like. The microcomputer provides various types of computation functions. The functions provided by the microcomputer can be provided through software recorded in a tangible memory apparatus and a computer that runs the software, only software, only hardware, or a combination thereof. For example, the microcomputer may implement a program stored in a non-transitory, tangible, computer-readable storage medium serving as a storage unit provided in the microcomputer itself. For example, the program may include programs related to an object recognition process for recognizing an object in the own vehicle vicinity, and a process for avoiding a collision with the object in the own vehicle vicinity or mitigating damage during a collision. A method corresponding to the program is performed by the microcomputer running the program. The storage unit may be, for example, a non-volatile memory. Here, for example, the program stored in the storage unit can be updated over a network such as the Internet.

The ECU 10 acquires object detection information from each of the cameras 21 and the radar apparatuses 22, and recognizes the object in the own vehicle vicinity based on these pieces of information. Specifically, the ECU 10 calculates a relative position, a presence region, and the like of the object as image information, from the distance to the object and the orientation of the object calculated from the camera image. In addition, the ECU 10 calculates the relative position, the presence region, and the like of the object as radar information, from the distance to the object and the orientation of the object included in the distance information acquired from the radar apparatus 22. The ECU 10 then recognizes the object by integrating (fusing) the image information and the radar information. At this time, the object is recognized based on overlapping of the presence region of the object included in the image information and the presence region of the object included in the radar information. However, according to the present embodiment, a method for object recognition is arbitrary. For example, the object can be recognized based on only the object detection information from the camera 21 or only the object detection information from the radar apparatus 22, of the object detection information from the camera 21 and the radar apparatus 22.

The ECU 10 performs adaptive cruise control (ACC) as the travel assistance control for the own vehicle. Specifically, the ECU 10 performs constant-speed travel control of the own vehicle based on a target speed set by the driver. In addition, in a case in which a preceding vehicle traveling ahead of the own vehicle in the travelling direction is present, the ECU 10 performs tracking control to cause the own vehicle to travel such as to track the preceding vehicle while maintaining a predetermined target inter-vehicle distance. In this case, the ECU 10 searches for the preceding vehicle serving as a tracking target ahead of the own vehicle in the travelling direction during execution of ACC. If the preceding vehicle is not present, the ECU 10 causes the own vehicle to travel at a constant speed, at the target speed. In addition, if the preceding vehicle is present, the ECU 10 causes the own vehicle to travel while maintaining the inter-vehicle distance to the preceding vehicle at the target inter-vehicle distance. At this time, the ECU 10 performs speed control by adjusting a driving force and a braking force of the own vehicle using the controlled apparatus 30 to control the speed of the own vehicle.

According to the present embodiment, the accelerator apparatus 31 and the brake apparatus 32 are mounted in the own vehicle as the controlled apparatuses 30. The accelerator apparatus 31 is an engine or a motor that serves as a power source of the own vehicle. When the driver operates the accelerator, the accelerator apparatus 31 applies driving force to the own vehicle based on a control command from the ECU 10. The brake apparatus 32 is provided in each wheel of the vehicle. When the driver operates the brakes, the brake apparatus 32 applies braking force to the own vehicle based on a control command from the ECU 10.

Here, the driver is capable of turning on and off ACC. For example, the ECU 10 may perform ACC by the driver turning on a set switch. In addition, the ECU 10 stops ACC when a predetermined cancel condition is met, such as the driver turning off the set switch.

Furthermore, according to the present embodiment, in ACC, deceleration control in which the own vehicle is decelerated is performed based on map information acquired from the navigation apparatus 40. That is, the ECU 10 performs the deceleration control to decelerate the own vehicle based on road conditions ahead of the own vehicle in the travelling direction using the map information. In this case, the navigation apparatus 40 acquires own vehicle position information that is information on a current position of the own vehicle, and the map information. For example, the own vehicle position information may be acquired by a vehicle position sensor using GPS or a global navigation satellite system (GNSS).

The map information includes information on roads that can be traveled by a vehicle, as well as information on road shape, information on a stop position on a road, information related to traffic lights, information on right-of-way priority, and the like. The information on road shape includes information indicating the road may be, for example, a curved road, a T-shaped intersection, a roundabout, or a tollgate. The curved road, the T-shaped intersection, the roundabout, and the tollgate are road shapes that require deceleration of the vehicle when present in the travelling direction of the vehicle. Here, the road shapes that require deceleration are also referred to as deceleration landmarks. Other information indicating road shape may include information indicating the road is an intersection where a speed limit sign, a stop sign, or a yield sign (give way sign) is set.

The ECU 10 acquires the own vehicle position information and the map information from the navigation apparatus 40, and performs the deceleration control of the own vehicle in a preceding zone immediately before the own vehicle reaches the deceleration landmark such as an intersection stop position, based on the own vehicle position information and the map information. At this time, the brake apparatus 32 performs braking based on the position to the deceleration landmark and the like, and the own vehicle is decelerated. Vehicle deceleration by deceleration control is prioritized over speed control by constant-speed travel control and tracking control. Here, an intersection applicable as the deceleration landmark is assumed to be an intersection without traffic lights where a priority road and a non-priority road intersect in a T-shape or a cross-shape, and the own vehicle enters the priority road from the non-priority road.

Here, in a case in which the driver of the own vehicle operates the accelerator in a state in which the deceleration control is being performed based on the map information, the operation of the accelerator may be interpreted as an intent to accelerate by the driver, and the deceleration control may be canceled. However, in a case in which the accelerator is erroneously operated and the deceleration control is canceled in accompaniment with the erroneous operation of the accelerator, occurrence of unintentional acceleration and the like of the vehicle immediately after cancellation of the deceleration control becomes a concern. Meanwhile, the map information may contain an error. In a case in which the deceleration control is performed based on erroneous map information, the deceleration control is preferably canceled by the driver operating the accelerator. For example, in a case in which the map information used by the navigation apparatus 40 is old information (outdated information) or temporary road construction is being performed, the deceleration control may be performed based on erroneous map information.

Therefore, according to the present embodiment, the deceleration control is canceled based on travel information of at least either of the own vehicle and another vehicle traveling in a same direction as the own vehicle in the own vehicle vicinity in a state in which the deceleration control is being performed based on the map information. In this case, whether the accelerator has been erroneously operated during the deceleration control or the deceleration control is being performed based on erroneous map information can be determined. Whether the accelerator operation by the driver is valid or invalid can be accurately determined.

FIG. 2 is a diagram of an example of a travel scene of an own vehicle CA. In FIG. 2, a T-shaped intersection is shown as an intersection without traffic lights where a priority road R1 and a non-priority road R2 intersect. The own vehicle CA is traveling on the non-priority road R2 toward the T-shaped intersection. A position immediately before the T-shaped intersection, that is, an entry to the intersection is a vehicle stop position ahead of the own vehicle CA in the travelling direction. In addition, a preceding vehicle CB is traveling on the non-priority road R2 as another vehicle ahead of the own vehicle CA. Here, a similar travel scene is assumed for not only the T-shaped intersection but a cross-shaped intersection as well, if the intersection is without traffic lights where the priority road R1 and the non-priority road R intersect.

In the travel scene shown in FIG. 2, when ACC is performed in the own vehicle CA, the own vehicle speed is controlled to maintain an inter-vehicle distance D1 between the own vehicle CA and the preceding vehicle CB at the target inter-vehicle distance. In addition, when the preceding vehicle CB is not present, the own vehicle speed is controlled based on a predetermined target speed.

Furthermore, in the own vehicle CA, a T-shaped road being ahead of the own vehicle is ascertained based on the map information, and the deceleration control is performed in a predetermined zone before the T-shaped intersection. In this case, for example, a rate of deceleration of the own vehicle CA may be controlled based on a distance from the own vehicle CA to the T-shaped intersection. As a result, the own vehicle speed gradually decreases as the own vehicle CA approaches the T-shaped intersection.

A scene in which the driver of the own vehicle CA operates the accelerator during execution of the deceleration control can be considered. Here, in a case in which the T-shaped intersection as shown in FIG. 2 is actually present ahead of the own vehicle CA in the travelling direction, the operation of the accelerator by the driver is likely to have been erroneously performed, and the cancellation of the deceleration control is undesirable. However, conversely, a case in which the T-shaped intersection is present ahead of the own vehicle CA in the travelling direction based on the map information, but the map information is erroneous and the T-shaped intersection is not actually present, that is, deceleration of the own vehicle CA is unnecessary can also be considered. In this case, the intent of the driver to accelerate in accompaniment with the operation of the accelerator not being reflected is undesirable.

When the own vehicle speed decreases as a result of the deceleration control, if the driver intends to accelerate, the driver operates the accelerator to actually increase the own vehicle speed. In this case, in the ACC system, a target acceleration set based on the accelerator operation amount by the driver and a target acceleration set based on a positional relationship with the preceding vehicle and the like are compared. Of the two target accelerations, if the former target acceleration (the target acceleration requested by the driver) is greater toward a positive side, acceleration of the own vehicle CA based on driver request based on the target acceleration is performed. Therefore, the own vehicle speed returns to or near the own vehicle speed before deceleration. Thus, according to the present embodiment, a speed return parameter that indicates a state of increase and return of the own vehicle speed after the start of accelerator operation during the deceleration control is acquired, and the deceleration control is canceled based on the speed return parameter.

A configuration of the ECU 10 related to the deceleration control will be described. In FIG. 1, the ECU 10 includes an ACC unit 11, an accelerator operation determination unit 12, a parameter acquisition unit 13, and a deceleration control unit 14. The ACC unit 11 performs the constant-speed travel control based on the target speed as described above, the tracking control tracking the preceding vehicle, and the deceleration control based on the map information.

The accelerator operation determination unit 12 determines whether the driver of the own vehicle is operating the accelerator in a state in which the deceleration control is performed based on the map information. Whether the accelerator is operated is determined based on a detection signal from the acceleration sensor 24.

The parameter acquisition unit 13 acquires the speed return parameter that indicates the state of increase and return of the own vehicle speed after the start of accelerator operation in a state in which the deceleration control is performed based on the map information. The speed return parameter corresponds to travel information of the own vehicle and may be, for example, an own vehicle speed.

The deceleration control unit 14 cancels the deceleration control based on the own vehicle speed (speed return parameter) acquired by the parameter acquisition unit 13 in a state in which the deceleration control is performed based on the map information. Specifically, the own vehicle speed and a predetermined threshold TH1 are compared, and the deceleration control is canceled based on the result.

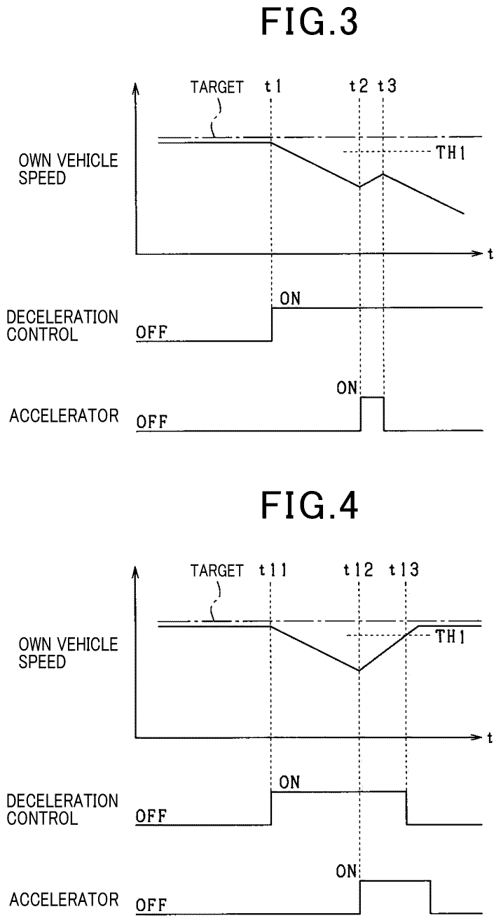

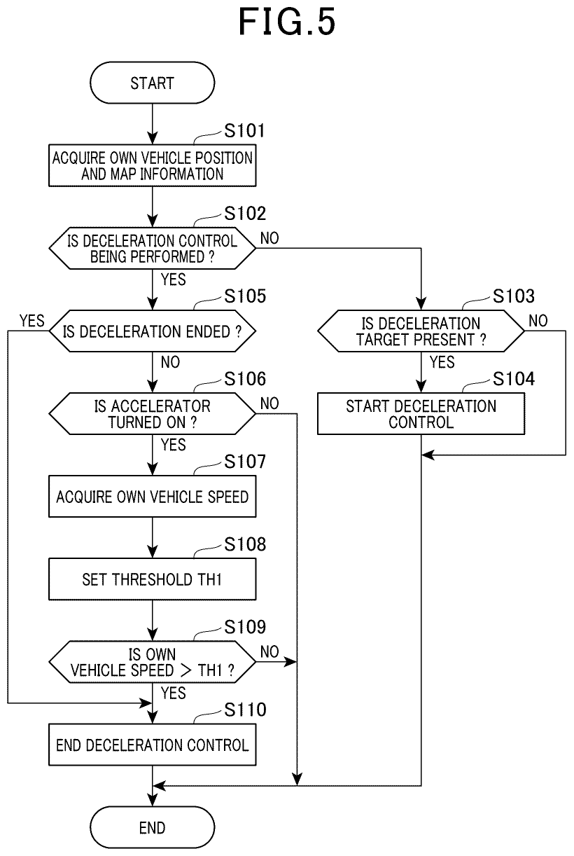

The deceleration control according to the present embodiment will be described in more detail below. Here, a control mode in which whether to cancel the deceleration control is determined based on the own vehicle speed serving as the speed return parameter is described. FIG. 3 is a time chart of a state in which the map information is accurate information and the deceleration control is appropriately performed. FIG. 4 is a time chart of a state in which the map information is erroneous information and the deceleration control is not appropriately performed. Here, in a chart indicating the own vehicle speed in FIG. 3 and FIG. 4, a single-dot chain line indicates the target speed.

In FIG. 3, before timing t1, travel of the own vehicle is controlled by ACC and the own vehicle is traveling at the target speed. That is, the own vehicle speed and the target speed substantially coincide. At timing t1, the deceleration control is started based on the own vehicle position and the map information. As a result, the own vehicle speed gradually decreases from timing t1.

Then, at timing t2, the driver operates the accelerator in the own vehicle and the own vehicle speed changes so as to increase. At this time, because the accelerator operation is performed within a relatively short period (a period from t2 to t3), an amount of increase in the own vehicle speed is not very large and the own vehicle speed remains less than the threshold TH1 for determining the return of the own vehicle speed. Therefore, the deceleration control is continued. In this case, because the map information is accurate, even if the driver erroneously temporarily operates the accelerator, the accelerator operation is invalidated and the deceleration control is continued.

The threshold TH1 is a speed threshold for determining whether the own vehicle speed has returned to the target speed in accompaniment with the accelerator operation when the own vehicle speed decreases after the start of deceleration control. The target speed is a target value of the own vehicle speed prescribed before timing t1. Specifically, the threshold TH1 may be a speed threshold obtained by multiplying the target speed with a reduction correction amount K (K≤1). That is, the threshold TH1 is “target speed×K”. For example, the target threshold TH1 may be a speed that is about 80% of the target speed. In this case, the reduction correction value K is a value of about 0.8. Here, the threshold TH1 may be a speed obtained by subtracting a predetermined value a from the target speed (TH1=target speed−α). In this case, the predetermined value a may be about several km/h (such as 5 km/h). The threshold TH1 may be a value that is same or slightly less than the target speed.

At timing t3 and subsequent thereto, the own vehicle speed decreases again as a result of the deceleration control, in accompaniment with cancellation of the accelerator operation.

Meanwhile, in FIG. 4, in a manner similar to FIG. 3, the own vehicle travels at the target speed as a result of ACC before timing t11. At timing t11 and subsequent thereto, the own vehicle speed gradually decreases as a result of the start of deceleration control based on the map information.

Then, at timing t12, the driver operates the accelerator in the own vehicle and the own vehicle speed changes so as to increase. At this time, because the driver intends to accelerate and operates the accelerator for a relatively long period, the own vehicle speed increases to the threshold TH1. In this case, to prioritize the accelerator operation (the intent to accelerate) by the driver, the deceleration control is canceled at timing t13 when the own vehicle speed reaches the threshold TH1. At timing t13 and subsequent thereto, the own vehicle speed is controlled to a state before the start of deceleration control, that is, the constant-speed traveling control.

Here, the own vehicle speed immediately before the start of deceleration control substantially coincides with the target speed. Therefore, the configuration can also be such that the threshold TH1 is set based on the own vehicle speed immediately before the start of deceleration control. In this case, the threshold TH1 is prescribed as “the own vehicle speed immediately before the start of deceleration control×K”.

FIG. 5 is a flowchart of processing steps in the deceleration control performed based on the map information. The ECU 10 repeatedly performs the present process at a predetermined cycle. The present process presumes ACC is being performed in the own vehicle.

In FIG. 5, at step S101, the ECU 10 acquires the own vehicle position information and the map information from the navigation apparatus 40. At step S102, the ECU 10 determines whether a current state is such that the deceleration control is being performed, that is, whether deceleration by the deceleration control is being performed in the own vehicle. When determined that the state is not such that the deceleration control is being performed, the ECU 10 proceeds to step S103. At step S103, the ECU 10 determines whether a deceleration landmark for which deceleration is to be performed is present ahead of the own vehicle in the travelling direction using the own vehicle position information and the map information acquired from the navigation apparatus 40. Specifically, the ECU 10 determines whether the deceleration landmark including a T-shaped intersection, a roundabout, and the like is present ahead of the own vehicle. Then, when determined that the deceleration landmark is not present ahead of the own vehicle in the travelling direction, the ECU 10 temporarily ends the present process. When determined that the deceleration landmark is present ahead of the own vehicle in the travelling direction, the ECU 10 proceeds to step S104. At step S104, the ECU 10 starts the deceleration control of the own vehicle. Control to decelerate the own vehicle speed based on the distance from the own vehicle position to the deceleration landmark is performed after the start of deceleration control.

Meanwhile, after the start of deceleration control, the ECU 10 determines YES at step S102 and proceeds to step S105. At step S105, the ECU 10 determines whether a timing for ending the deceleration control is reached. For example, if the own vehicle has arrived at the deceleration landmark, the ECU 10 proceeds to step S110 and ends the deceleration control. If the own vehicle has not arrived at the deceleration landmark, the ECU 10 proceeds to step S106.

At step S106, the ECU 10 determines whether the driver is operating the accelerator of the own vehicle. At this time, the ECU 10 determines whether the accelerator is operated based on the detection signal from the accelerator sensor 24. Then, when determined that the accelerator is not operated, the ECU 10 immediately ends the present process. When determined that the accelerator is operated, the ECU 10 proceeds to subsequent step S107.

At step S107, the ECU 10 acquires the own vehicle speed. At subsequent step S108, the ECU 10 sets the threshold TH1. The own vehicle speed is a speed calculated from the detection signal from the speed sensor 23. At step S108, the ECU 10 sets the threshold TH1 by multiplying the target speed of the own vehicle by the reduction correction value K.

Then, at step S109, the ECU 10 determines whether the own vehicle speed is greater than the threshold TH1. When determined that the own vehicle speed is not greater than the threshold TH1, the ECU 10 ends the present process. In this case, the deceleration control is continued. In addition, when determined that the own vehicle speed is greater than the threshold TH1, the ECU 10 proceeds to subsequent step S110. At step S110, the ECU 10 ends the deceleration control.

According to the present embodiment described in detail above, the following excellent effects are achieved.

When the deceleration control is being performed based on the map information and the driver is determined to be operating the accelerator, the deceleration control is canceled based on the travel information of the own vehicle. In this case, based on the travel information of the own vehicle, whether the accelerator has been erroneously operated during the deceleration control based on the map information or the deceleration control has been performed based on erroneous map information can be determined. As a result, the deceleration control can be appropriately canceled upon accurate determination of whether the accelerator operation by the driver is valid or invalid. Consequently, vehicle deceleration control based on the map information can be appropriately performed.

When the own vehicle speed decreases as a result of deceleration control, if the driver intends to accelerate, the actual own vehicle speed increases in accompaniment with accelerator operation and returns to or near the own vehicle speed before deceleration. In light of this, the speed return parameter indicating the state of increase and return of the own vehicle speed after the start of the accelerator operation during the deceleration control is acquired, and the deceleration control is canceled based on the speed return parameter. Specifically, the deceleration control is canceled based on the own vehicle speed being greater than the threshold TH1 set based on the target speed. As a result, appropriate deceleration control can be performed while reflecting the intention of the driver.

Hereafter, other embodiments in which the first embodiment is partially modified will be described, mainly focusing on differences with the first embodiment.

### Second Embodiment

According to a present embodiment, the configuration is such that the deceleration control is canceled based on the own vehicle speed and the inter-vehicle distance between the own vehicle and the preceding vehicle when the driver operates the accelerator after the start of deceleration control.

Specifically, in FIG. 1, the parameter acquisition unit 13 acquires the own vehicle speed, and the inter-vehicle distance between the own vehicle and the preceding vehicle as the speed return parameters during the execution of deceleration control.

The deceleration control unit 14 cancels the deceleration control based on the own vehicle speed being greater than a threshold TH2 set based on a preceding vehicle speed, and the inter-vehicle distance to the preceding vehicle being less than the target inter-vehicle distance, during the execution of deceleration control. The preceding vehicle speed may be calculated from the own vehicle speed, and a relative speed of the own vehicle and the preceding vehicle. Alternatively, the preceding vehicle speed may be speed information of the preceding vehicle acquired through inter-vehicle communication between the own vehicle and the preceding vehicle, or speed information acquired through road-vehicle communication with a roadside apparatus.

The threshold TH2 is a speed threshold for determining whether the own vehicle speed has returned to a speed near the preceding vehicle speed in accompaniment with accelerator operation, when the own vehicle speed decreases after the start of deceleration control. Specifically, the threshold TH2 is a speed threshold obtained by multiplying the preceding vehicle speed by the reduction correction value K (K≤1). That is, the threshold TH2 is “preceding vehicle speed×K”. For example, the threshold TH2 may be a speed that is about 80% of the preceding vehicle speed. In this case, the reduction correction value His a value of about 0.8. Here, the threshold TH2 may be a speed obtained by subtracting a predetermined value a from the preceding vehicle speed (TH2=preceding vehicle speed−α). In this case, the predetermined value a may be about several km/h (such as 5 km/h). The threshold TH2 may be a value that is the same or slightly less than the preceding vehicle speed.

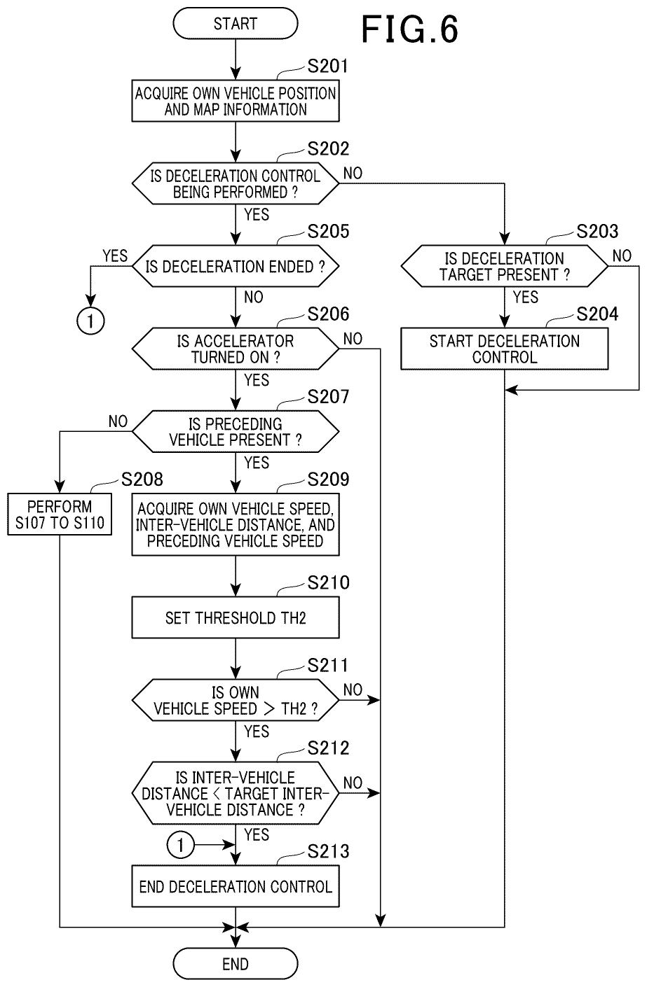

FIG. 6 is a flowchart of the processing steps in the deceleration control according to the present embodiment. The ECU 10 repeatedly performs the present process at a predetermined cycle. The present process presumes that ACC is being performed in the own vehicle.

In FIG. 6, steps S201 to S206 are the same processes as those of steps S101 to S106 in FIG. 5. Here, steps S201 to S206 will be briefly described. After the ECU 10 acquires the own vehicle position information and the map information from the navigation apparatus 40 (step S201), when determined that the current state is not that in which deceleration control is being performed (NO at step S202), the ECU 10 determines whether the deceleration landmark is present ahead of the own vehicle in the travelling direction (step S203). Then, when determined that the deceleration landmark is present ahead of the own vehicle in the travelling direction, the ECU 10 starts the deceleration control of the own vehicle (step S204). In addition, after the start of deceleration control, when determined that the timing for ending the deceleration control is not yet reached, the ECU 10 determines whether the driver of the own vehicle is operating the accelerator (steps S205 and S206). Then, when determined that the driver is operating the accelerator, the ECU 10 proceeds to subsequent step S207.

At step S207, the ECU 10 determines whether a preceding vehicle to be tracked is present ahead of the own vehicle in the travelling direction. When determined that the preceding vehicle is not present, the ECU 10 proceeds to step S208. Upon proceeding to step S208, the ECU 10 performs a process to determine whether to continue or cancel the deceleration control based on a comparison between the own vehicle speed and the threshold TH1 (the speed threshold set based on the target speed). This process corresponds to steps S107 to S110 in FIG. 5 and a description thereof is omitted herein.

In addition, when determined that the preceding vehicle is present, the ECU 10 proceeds to step S209. At step S209, the ECU 10 acquires the own vehicle speed, the inter-vehicle distance between the own vehicle and the preceding vehicle, and the preceding vehicle speed. At subsequent S210, the ECU 10 sets the threshold TH2 based on the preceding vehicle speed. At this time, the ECU 10 sets the threshold TH2 by multiplying the current preceding vehicle speed by the reduction correction value K.

Then, at step S211, the ECU 10 determines whether the own vehicle speed is greater than the threshold TH2. At subsequent step S212, the ECU 10 determines whether the inter-vehicle distance to the preceding vehicle is less than the target inter-vehicle speed. Then, when determined NO at either of the steps S211 and S212, the ECU 10 ends the present process. In this case, the deceleration control is continued. In addition, when determined YES at both of steps S211 and S212, the ECU 10 proceeds to subsequent S213. At step S213, the ECU 10 ends the deceleration control.

According to the present embodiment, the deceleration control is canceled based on the own vehicle speed being greater than the threshold TH2 set based on the preceding vehicle speed and the inter-vehicle distance to the preceding vehicle being less than the target inter-vehicle distance, during execution of the deceleration control. Consequently, appropriate deceleration control can be performed while reflecting the intentions of the driver.

As a variation example according to the present embodiment, a following configuration can be used. That is, the configuration can be such that, when the driver operates the accelerator after the start of deceleration control, of the own vehicle speed being greater than the threshold TH2 set based on the preceding vehicle speed (step S211) and the inter-vehicle distance to the own vehicle being less than the target inter-vehicle distance (step S212), the deceleration control is canceled based only on the own vehicle speed being greater than the threshold TH2 (step S211). In this case, in FIG. 6, the process at step S212 is omitted.

Here, when the deceleration control is started based on the map information, if the map information is accurate, the own vehicle speed decreases as a result of the deceleration control, and the preceding vehicle speed also decreases. In this case, because both the own vehicle speed and the preceding vehicle speed decrease, a difference between the two speeds is unlikely to occur. Therefore, even in a state in which the map information is accurate, that is, the deceleration control is appropriately performed, the own vehicle speed may become greater than the threshold TH2 at step S209 and the deceleration control being canceled at step S211 as a result can be considered. However, after the deceleration control is canceled, the own vehicle is decelerated so as to match the preceding vehicle through tracking control relative to the preceding vehicle. Therefore, it is thought that, in practical terms, issues do not occur in the travel of the own vehicle.

### Third Embodiment

When the deceleration control is performed in the own vehicle based on the map information, if the map information is erroneous, the preceding vehicle traveling ahead of the own vehicle exhibits behavior counter to the deceleration of the own vehicle. Therefore, according to a present embodiment, an other vehicle behavior parameter indicating behavior of the preceding vehicle counter to the deceleration of the own vehicle is acquired and the deceleration control is canceled based on the other vehicle behavior parameter.

According to the present embodiment, in the ECU 10 shown in FIG. 1, the parameter acquisition unit 13 acquires the other vehicle behavior parameter indicating behavior of the preceding vehicle ahead of the own vehicle counter to the deceleration of the own vehicle in a state in which the deceleration control is performed based on the map information. The other vehicle behavior parameter corresponds to travel information of the preceding vehicle and may be, for example, the preceding vehicle speed.

The deceleration control unit 14 cancels the deceleration control based on the preceding vehicle speed (other vehicle behavior parameter) acquired by the parameter acquisition unit 13 in the state in which the deceleration control is performed based on the map information.

Specifically, the deceleration control unit 14 compares the preceding vehicle speed and a threshold TH3 set based on the target speed for constant-speed travel control, and cancels the deceleration control based on the result. That is, if the map information is erroneous during the deceleration control, the state is such that, while the own vehicle decelerates, the preceding vehicle does not decelerate (see FIG. 4). In this case, the deceleration control unit 14 cancels the deceleration control based on the preceding vehicle speed being greater than the threshold TH3 set based on the target speed of the own vehicle.

The threshold TH3 may be a value obtained by adding a predetermined value β to the target speed (TH3=target speed+β). For example, the predetermined value β may be about 0 to several km/h. Here, the threshold TH3 may be a speed threshold obtained by multiplying the target speed by a correction value K2 (K2≥1). The threshold TH3 may be a value that is the same as or slightly greater than the target speed. The preceding vehicle speed being greater than the threshold TH3 means that the preceding vehicle speed has not decreased during the deceleration control, that is, the preceding vehicle is not in a state of deceleration.

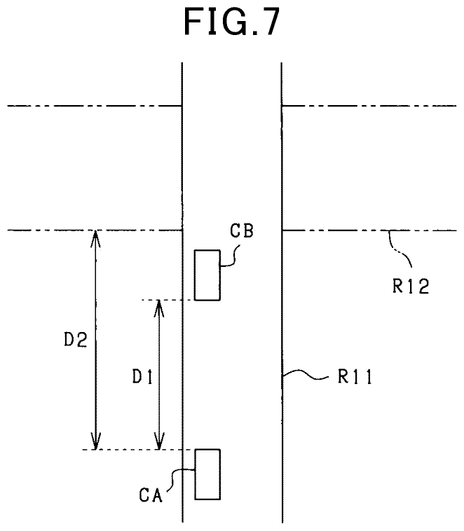

In addition, during the execution of deceleration control, if the map information is erroneous, the preceding vehicle travels without decelerating even upon arriving near the deceleration landmark ahead in the travelling direction. This travel scene is shown in FIG. 7. Here, FIG. 7 shows a state in which a road R11 on which the own vehicle CA is traveling is erroneously recognized as intersecting with an intersecting road R12 on the map. In this case, the deceleration control is performed using the intersection between the roads R11 and R12 as the deceleration landmark. In FIG. 7, an inter-vehicle distance between the own vehicle CA and the preceding vehicle CB is D1, and a distance from the own vehicle CA to the intersection (deceleration landmark) on the map is D2.

During execution of the deceleration control, the deceleration control unit 14 cancels the deceleration control based on the preceding vehicle CB not being in a state of deceleration while approaching a predetermined distance to a position of the deceleration landmark ahead in the travelling direction in the map information. The preceding vehicle CB approaching the predetermined distance to the position of the deceleration landmark in the map information means that the inter-vehicle distance D1 is longer than a distance obtained by subtracting a predetermined value ΔD from the distance D2 to the deceleration landmark. That is, “D1≥D2−ΔD”. For example, the predetermined value ΔD is about 0 to several m.

The determination that the preceding vehicle CB is not in a state of deceleration can be made through comparison of the preceding vehicle speed and the threshold TH3, as described above. In addition, the configuration may be such that, to determine that the preceding vehicle CB is not in a state of deceleration, a rate of decrease per unit time of the preceding vehicle speed (a rate of deceleration of the preceding vehicle) is determined to be less than a predetermined rate of decrease. In this case, the preceding vehicle speed and the rate of deceleration of the preceding vehicle are the other vehicle behavior parameters. In addition, the preceding vehicle speed and the rate of deceleration of the preceding vehicle correspond to preceding vehicle deceleration information indicating whether the preceding vehicle is in a state of deceleration.

The other vehicle behavior parameter (preceding vehicle deceleration information) may be information indicating that a brake operation (depressing of a brake pedal) is not performed in the preceding vehicle CB. For example, information on non-operation of the brakes may be based on a brake light of the preceding vehicle CB not illuminating, or preceding vehicle brake information acquired through inter-vehicle communication or the like.

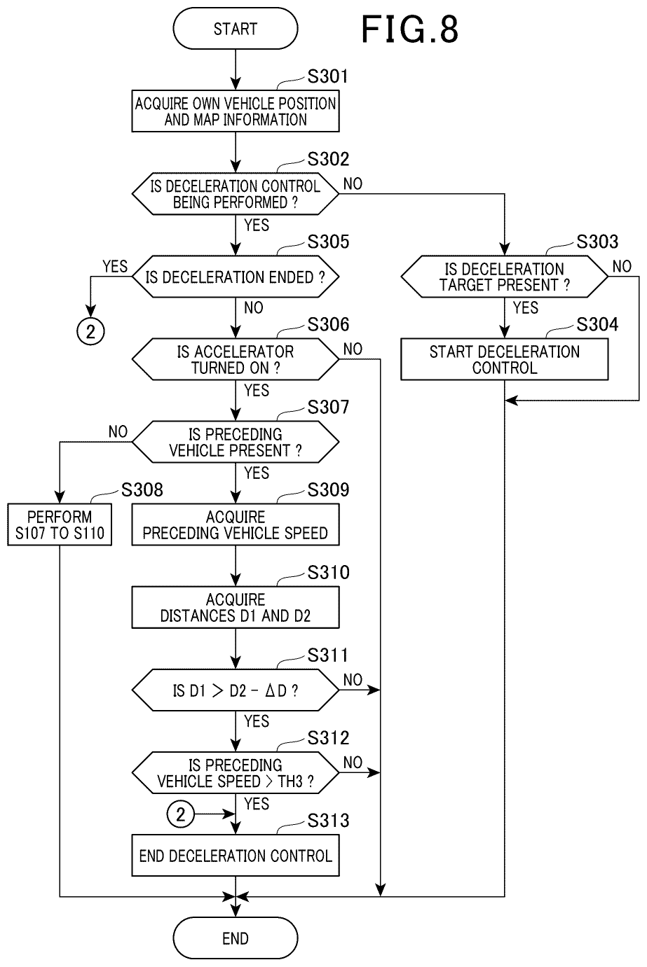

FIG. 8 is a flowchart of the processing steps in the deceleration control according to the present embodiment. The ECU 10 repeatedly performs the present process at a predetermined cycle. The present process presumes that ACC is being performed in the own vehicle.

In FIG. 8, steps S301 to S306 are the same processes as those of steps S101 to S106 in FIG. 5. Here, steps S301 to S306 will be briefly described. After the ECU 10 acquires the own vehicle information and the map information from the navigation apparatus 40 (step S301), when determined that the current state is not that in which deceleration control is being performed (NO at step S302), the ECU 10 determines whether the deceleration landmark is present ahead of the own vehicle in the travelling direction (step S303). Then, when determined that the deceleration landmark is present ahead of the own vehicle in the travelling direction, the ECU 10 starts the deceleration control of the own vehicle (step S304). In addition, after the start of deceleration control, when determined that the timing for ending the deceleration control is not yet reached, the ECU 10 determines whether the driver of the own vehicle is operating the accelerator (steps S305 and S306). Then, when determined that the driver is operating the accelerator, the ECU 10 proceeds to subsequent step S307.

At step S307, the ECU 10 determines whether the preceding vehicle to be tracked is present ahead of the own vehicle in the travelling direction. When determined that the preceding vehicle is not present, the ECU 10 proceeds to step S308. Upon proceeding to step S308, the ECU 10 performs a process to determine whether to continue or cancel the deceleration control based on the own vehicle speed. This process is corresponds to the processes at steps S107 to S110 in FIG. 5. A description thereof is omitted herein.

In addition, when determined that the preceding vehicle is present, the ECU 10 proceeds to step S309. At step S309, the ECU 10 acquires the preceding vehicle speed. At subsequent step S310, the ECU 10 acquires the inter-vehicle distance D1 between the own vehicle and the preceding vehicle, and the distance D2 from the own vehicle to the deceleration landmark on the map. Then, at step S311, the ECU 10 determines whether the inter-vehicle distance D1 is longer than a distance obtained by subtracting the predetermined value ΔD from the distance D2 to the deceleration landmark (whether D1>D2−ΔD). At subsequent step S312, the ECU 10 determines whether the preceding vehicle speed is greater than the threshold TH3 set based on the target speed of the own vehicle. Here, step S312 corresponds to a process for determining whether the preceding vehicle is not in a state of deceleration.

Then, when determined NO at either of steps S311 and S312, the ECU 10 ends the present process. In this case, the deceleration control is continued. In addition, when determined YES at both steps S311 and S312, the ECU 10 proceeds to subsequent step S313. At step S313, the ECU 10 ends the deceleration control.

Here, the processes at steps S310 and S311 can be omitted. In this case, after the deceleration control is started, when determined that the driver of the own vehicle is operating the accelerator and a preceding vehicle is present ahead of the own vehicle in the travelling direction, the ECU 10 ends the deceleration control (step S313) when determined that the preceding vehicle speed is greater than the threshold TH3 (YES at step S312).

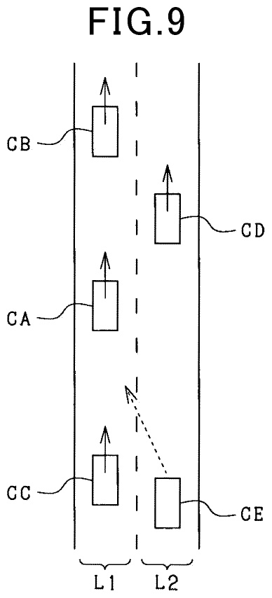

Another vehicle may be present in any position ahead, behind, or to the left or right of the own vehicle on the road on which the own vehicle is traveling. The other vehicle is another vehicle traveling in the same direction as the own vehicle in the vicinity of the own vehicle. For example, in FIG. 9, the own vehicle CA is traveling in an own lane L1 on a road having two traffic lanes L1 and L2 that have the same travelling direction and are adjacent to each other. In addition, the preceding vehicle CB is traveling ahead of the own vehicle CA in the own lane L1, a following vehicle CC is traveling behind the own vehicle CA, and a lateral vehicle CD is traveling near the own vehicle CA in the adjacent lane L2.

In this case, the other vehicle behavior parameter may be a parameter indicating the traveling state of the lateral vehicle CD or the traveling state of the following vehicle CC, in addition to the parameter indicating the traveling state of the preceding vehicle CB. That is, in a case in which the deceleration control is being performed based on erroneous map information, in addition to the preceding vehicle CB, the lateral vehicle CD and the following vehicle CC may also exhibit behavior counter to the deceleration of the own vehicle CA.

Therefore, if the lateral vehicle CD is present during the deceleration control of the own vehicle CA, the ECU 10 may acquire the travel speed and the like of the lateral vehicle CD as the other vehicle behavior parameter, and cancel the deceleration control based on the travel speed and the like of the lateral vehicle CD. A method for canceling the deceleration control based on the travel speed and the like of the lateral vehicle CD corresponds to the method for canceling the deceleration control based on the travel speed and the like of the preceding vehicle CB, described above.

In addition, if the following vehicle CC is present during the deceleration control of the own vehicle CA, the ECU 10 may acquire the travel speed and the like of the following vehicle CC as the other vehicle behavior parameter, and cancel the deceleration control based on the travel speed and the like of the following vehicle CC. In this case, the deceleration control is canceled when the following vehicle CC has not recognized the deceleration landmark ahead in the travelling direction, regardless of the deceleration control being performed in the own vehicle CA.

As the control related to the following vehicle CC, specifically, the deceleration control may be canceled when the own vehicle speed is slower than the following vehicle speed and a relative speed of the own vehicle CA to the following vehicle CC (own vehicle speed-following vehicle speed) is less than a predetermined value during the deceleration control. Alternatively, the deceleration control may be canceled when the inter-vehicle distance between the own vehicle CA and the following vehicle CC is less than a predetermined value during the deceleration control.

As shown in FIG. 9, the deceleration control may be canceled when a rear-lateral vehicle CE traveling behind the own vehicle in the adjacent lane L2 changes traffic lanes from the adjacent lane L2 to the own lane L1 and moves to a position directly behind the own vehicle in the own lane L1 during the deceleration control. Alternatively, the deceleration control may be canceled when the rear-lateral vehicle CE changes traffic lanes and moves to the position directly behind the own vehicle in the own lane L1 in a state in which the following vehicle CC is not present, during the deceleration control. Furthermore, the deceleration control may be canceled when the rear-lateral vehicle CE indicates an intention to move to the position directly behind the own vehicle in the own vehicle lane L1 by turning on a turn signal.

Here, in the configuration in which the deceleration control is canceled based on the travel information of the following vehicle CC, whether to cancel the deceleration control may be determined based on the type of the deceleration landmark. For example, if the deceleration landmark ahead of the own vehicle in the travelling direction is a yield sign (a deceleration target having a relatively low deceleration requirement), the deceleration control may be canceled. If the deceleration landmark ahead of the own vehicle in the travelling direction is other than the yield sign, such as a T-shaped intersection, a roundabout, or the like, the deceleration control may not be canceled.

According to the present embodiment described in detail above, the following effects are achieved.

When the deceleration control is performed in the own vehicle based on the map information, if the map information is erroneous, other vehicles in the own vehicle vicinity exhibit behavior counter to the deceleration of the own vehicle. In light of this point, the other vehicle behavior parameter indicating the behavior of the preceding vehicle, for example, counter to the deceleration of the own vehicle is acquired during the deceleration control, and the deceleration control is canceled based on the other vehicle behavior parameter. As a result, appropriate deceleration control can be performed while reflecting the intentions of the driver and appropriately ascertaining whether the map information is accurate.

During the execution of deceleration control, if the map information is erroneous, the state is such that the preceding vehicle does not decelerate while the own vehicle decelerates. In this case, the deceleration control can be appropriately canceled as a result of the preceding vehicle speed being greater than the threshold TH3 set based on the target speed of the own vehicle.

During the execution of deceleration control, if the map information is erroneous, the preceding vehicle travels without decelerating even after arriving at the deceleration landmark ahead in the travelling direction. In other words, the preceding vehicle not decelerating even when approaching the predetermined distance to the deceleration landmark ahead in the travelling direction indicates a high likelihood of the deceleration landmark on the map being erroneous. In this case, the deceleration control can be appropriately canceled based on the preceding vehicle being near the deceleration landmark ahead in the travelling direction in the map information and not being in a state of deceleration.

### Fourth Embodiment

According to a present embodiment, in the configuration in which, after the start of deceleration control, the deceleration control is canceled based on the result of the comparison between the own vehicle speed that is the speed return parameter and the threshold TH1 (for example, see the flowchart in FIG. 5), the threshold TH1 is variably set. According to the present embodiment, the ECU 10 corresponds to a threshold setting unit.

During the deceleration control, the intention of the driver to accelerate can be determined based on the acceleration of the own vehicle (own vehicle acceleration) occurring in accompaniment with the driver operating the accelerator. In this case, a probability that the map information used for the deceleration control is erroneous is thought to increase as the own vehicle acceleration increases. Taking this into consideration, the threshold TH1 is variably set based on the own vehicle acceleration.

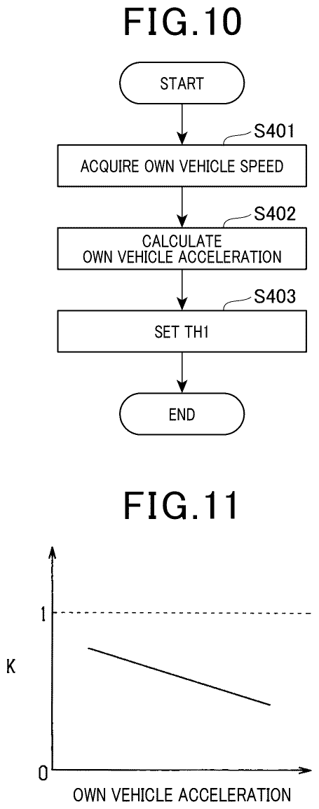

FIG. 10 is a flowchart of steps in a threshold setting process. The ECU 10 repeatedly performs the present process at a predetermined cycle. The present process is performed during the deceleration control, and more specifically, may be performed at step S108 in the flowchart in FIG. 5.

In FIG. 10, at step S401, the ECU 10 acquires the own vehicle speed. At subsequent step S402, the ECU 10 calculates the own vehicle acceleration by differential operation of the own vehicle speed. At step S403, the ECU 10 sets the reduction correction value K based on the own vehicle acceleration, and sets the threshold TH1 based on the reduction correction value K and the target speed.

FIG. 11 is a diagram of a relationship between the own vehicle acceleration and the reduction correction value K. In FIG. 11, the reduction correction value K is a value that is 1 or less and is prescribed a relationship in which the reduction correction value K decreases as the own vehicle acceleration increases. The threshold TH1 is a speed threshold obtained by multiplying the target speed by the reduction correction value K. The threshold TH1 decreases as the reduction correction value K decreases. The threshold TH1 being a small value means that the deceleration control is more easily canceled after the start of deceleration control.

Here, in FIG. 11, the reduction correction value K may be variably set to multiple levels (such as two levels or more) based on the own vehicle acceleration. In addition, the reduction correction value K may be selectively set between 1 and a value less than 1 based on the own vehicle acceleration.

According to the present embodiment, as a result of the threshold TH1 for canceling the deceleration control being variably set based on the own vehicle acceleration, accuracy with which the deceleration control is canceled can be improved.

### Other Examples According to the Fourth Embodiment

When another vehicle traveling in the own vehicle vicinity exhibits behavior counter to the deceleration of the own vehicle during the deceleration control, the probability that the map information used for the deceleration control is erroneous is high. Therefore, when the other vehicle is exhibiting behavior counter to the deceleration of the own vehicle, the deceleration control is preferably easily canceled. Taking this into consideration, the threshold TH1 may be variably set such that the deceleration control is easily canceled when the determination that the deceleration control should be canceled is made based on the other vehicle behavior parameter, compared to when the determination that the deceleration control should be canceled is not made. As a result, the accuracy with which the deceleration control is canceled can be improved.

In addition, in a case in which the determination that the deceleration control should be canceled is made based on the other vehicle behavior parameter in the own vehicle vicinity, reliability of the determination that the map information is erroneous is thought to differ depending on the position of the other vehicle for which the other vehicle behavior parameter is obtained in relation to the own vehicle, that is, whether the other vehicle is ahead, behind, or to the left or right of the own vehicle, or for how many other vehicles the other vehicle behavior parameter is obtained. Taking this into consideration, when the determination that the deceleration control should be canceled is made based on the other vehicle behavior parameter, the threshold TH1 may be variably set depending on the position of the other vehicle for which the other vehicle behavior parameter is obtained in relation to the own vehicle, that is, whether the other vehicle is ahead, behind, or to the left or right of the own vehicle, or for how many other vehicles the other vehicle behavior parameter is obtained.

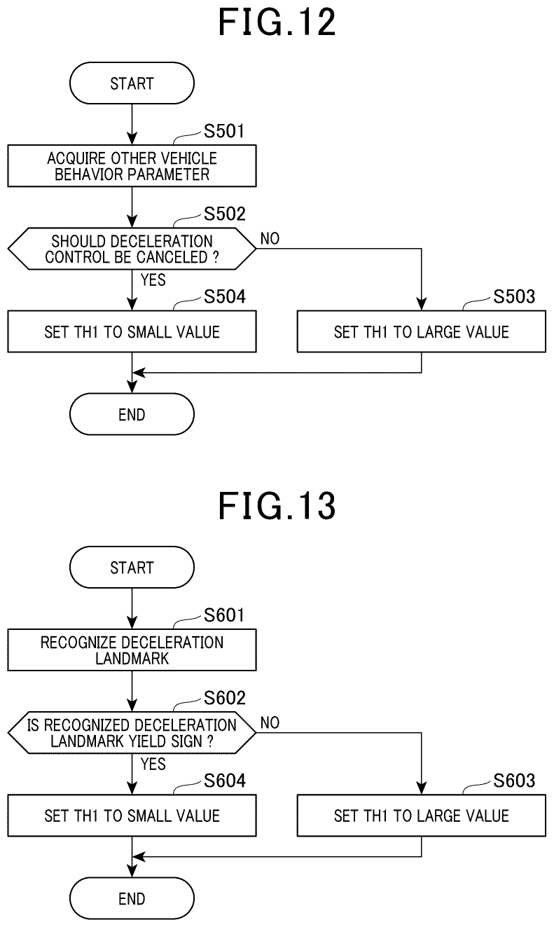

FIG. 12 is a flowchart of the steps in the threshold setting process. The ECU 10 repeatedly performs the present process at a predetermined cycle. The present process is performed during the deceleration control, and more specifically, may be performed at step S108 in the flowchart in FIG. 5.

In FIG. 12, at step S501, the ECU 10 acquires the other vehicle behavior parameter indicating behavior counter to the deceleration of the own vehicle for the other vehicle traveling in a position that is ahead, behind, or to the left or right of the own vehicle. For example, the other vehicle behavior parameter is a travel speed of the other vehicle. Then, at step S502, the ECU 10 determines whether the deceleration control should be canceled based on the other vehicle behavior parameter acquired at step S501. At this time, when the other vehicle behavior parameter is acquired for at least one vehicle among the other vehicles traveling in the vicinity of the own vehicle and the determination that the deceleration control should be canceled is made based on the other vehicle behavior parameter, the ECU 10 proceeds to step S503. When determined that the deceleration control should not be canceled, the ECU 10 proceeds to step S504.

At step S503, the ECU 10 sets the threshold TH1 to a relatively large value. At step S504, the ECU 10 sets the threshold TH1 to a relatively small value. In this case, when the determination that the deceleration control should be canceled is made based on the other vehicle behavior parameter, at step S504, the threshold TH1 is set such that the deceleration control is easily canceled, compared to when the determination that the deceleration control should not be canceled is made based on the other vehicle behavior parameter. Here, at steps S503 and S504, for example, the reduction correction value K may be set within a range of 0.5 to 1. At this time, at step S503, the reduction correction value K may be set to 1 at step S503. The reduction correction value K may be set to a value less than 1 at step S504.

At step S504, when determined that deceleration control should be canceled based on the other vehicle behavior parameter, the ECU 10 may set the threshold TH1 based on the position of the other vehicle for which the other vehicle behavior parameter is obtained in relation to the own vehicle, that is, whether the other vehicle is ahead, behind, or to the left or right of the own vehicle. In this case, reliability of the determination that the map information is erroneous based on the other vehicle behavior parameter is considered to be higher for the preceding vehicle positioned ahead of the own vehicle than the lateral vehicle on the left or right side or the following vehicle. Therefore, when the determination that the deceleration control should be canceled is made based on the other vehicle behavior parameter, the threshold TH1 is set to a relatively small value (a value allowing the deceleration control to be easily canceled) when the other vehicle for which the other vehicle behavior parameter is obtained is the preceding vehicle. When the other vehicle for which the other vehicle behavior parameter is obtained is a vehicle other than the preceding vehicle, the threshold TH1 is set to a relatively large value (a value preventing the deceleration control from being easily canceled).

Here, if the determination that the deceleration control should be canceled based on the other vehicle behavior parameter of the preceding vehicle and the determination that the deceleration control should be canceled based on the other vehicle behavior parameter of a vehicle other than the preceding vehicle both are made, the former determination result may be prioritized. In addition, the threshold TH1 may differ between when the determination that the deceleration control should be canceled is made based on the other vehicle behavior parameter for the lateral vehicle on the left or right side and when the determination that the deceleration control should be canceled is made based on the other vehicle behavior parameter for the following vehicle. For example, the threshold TH1 may be smaller for the former (lateral vehicle) than the latter (following vehicle).

Alternatively, when determined that the deceleration control should be canceled based on the other vehicle behavior parameter at step S504, the threshold TH1 may be set based on a number of other vehicles for which the other vehicle behavior parameter is obtained. In this case, when the determination that the deceleration control should be canceled is made based on the other vehicle behavior parameter, the reliability of the determination that the map information is erroneous based on the other vehicle behavior parameter is higher as the number of other vehicles based on which the determination is made increases. Therefore, when the determination that the deceleration control should be canceled is made based on the other vehicle behavior parameter, the threshold TH1 is a smaller value as the number of other vehicles for which the other vehicle behavior parameter is obtained increases (such as two vehicles or more), than when the number of vehicles is small (such as one vehicle).

A degree of deceleration requirement of the own vehicle differs depending on the type of deceleration landmark ahead of the own vehicle in the travelling direction. Taking this into consideration, the threshold TH1 may be variably set based on the type of the deceleration landmark ahead in the travelling direction. As a result, the reliability with which the deceleration control is canceled is improved.

FIG. 13 is a flowchart of the steps in the threshold setting process. The ECU 10 repeatedly performs the present process at a predetermined cycle. The present process is performed during the deceleration control, and more specifically, may be performed at step S108 in the flowchart in FIG. 5.

In FIG. 13, at step S601, the ECU 10 recognizes the deceleration landmark ahead of the own vehicle in the travelling direction based on the map information. At subsequent step S602, the ECU 10 determines whether the deceleration landmark recognized at step S601 is a yield sign. At this time, when the deceleration landmark ahead of the own vehicle in the travelling direction is not the yield sign, but rather, a T-shaped intersection, a roundabout, or the like that has a higher deceleration requirement than the yield sign, the ECU 10 proceeds to step S603. When the deceleration landmark ahead of the own vehicle is the yield sign, the ECU 10 proceeds to step S604.

At step S603, the ECU 10 sets the threshold TH1 to a relatively large value. At step S604, the ECU 10 sets the threshold TH1 to a relatively small value. In this case, at step S603, the threshold TH1 is set such that the deceleration control is relatively not easily canceled. At step S604, the threshold TH1 is set such that the deceleration control is relatively easily canceled. Here, at steps S603 and S604, for example, the reduction correction value K may be set within a range of 0.5 and 1. At this time, at step S603, the reduction correction value K may be set to 1. At step S604, the reduction correction value K may be set to a value less than 1.

### Other Embodiments

For example, the above-described embodiments may be modified in the following manner.

When the driver is determined to be operating the accelerator during the execution of deceleration control based on the map information, the deceleration control may be canceled by a following method.

When the driver is determined to be operating the accelerator during the execution of deceleration control, the deceleration control may be canceled under a condition that a duration of the accelerator operation in the own vehicle exceeds a predetermined amount of time. In this case, the duration of the accelerator operation corresponds to the travel information of the own vehicle and the speed return parameter.

When the driver is determined to be operating the accelerator during the execution of deceleration control, the deceleration control may be canceled under a condition that the target speed for the constant-speed travel control is changed toward the increasing side by an operation by the driver or the like. In this case, information indicating that the target speed is changed toward the increasing side corresponds to the travel information of the own vehicle.

When the driver is determined to be operating the accelerator during the execution of deceleration control, the deceleration control may be canceled under a condition that the road is a linear road on the map and a steering angle accompanying a steering operation by the driver is equal to or greater than a predetermined value. In this case, a travel scene in which the steering angle of the steering operation by the driver is equal to or greater than the predetermined value is thought to be a case in which the driver is intentionally changing traffic lanes or turning. The deceleration control can be appropriately canceled in this travel scene. In this case, the steering angle corresponds to the travel information of the own vehicle.

When the driver is determined to be operating the accelerator during the execution of deceleration control, the deceleration control may be canceled under a condition that the driver is operating the turn signal. In this case, the operation of the turn signal is an expression of the intention of the driver for vehicle travel. Vehicle travel desired by the driver can be implemented by the deceleration control being canceled. In this case, the information on the operation of the turn signal corresponds to the travel information of the own vehicle.

Here, as the travel scene in which the driver operates the turn signal, a scene in which the driver intends to change traffic lanes and a scene in which the driver intends to make a left or right turn can be considered. In this case, in the scene in which the driver intends to change traffic lanes, the deceleration control may hinder the travel intended by the driver. Therefore, the deceleration control may be canceled based on the operation of the turn signal. In contrast, in the scene in which the driver intends to make a left or right turn, particularly in a scene in which the left or right turn is made in a direction coinciding with a subsequent own vehicle travel route (such as a travel guidance route by the navigation apparatus 40), the deceleration control does not necessarily hinder the travel intended by the driver. The deceleration control may not be canceled even when the turn signal is operated.

When the driver is determined to be operating the accelerator during the execution of deceleration control, the deceleration control may be canceled under a condition that the preceding vehicle is no longer present as a result of lane change or a left or right turn, that is, the state changes from that in which the preceding vehicle is present to that in which the preceding vehicle is not present. Alternatively, when the driver is determined to be operating the accelerator during the execution of deceleration control, the deceleration control may be canceled under a condition that the preceding vehicle flashes either a left or right turn signal light immediately before operating the accelerator.

In the state in which the preceding vehicle is no longer present as a result of lane change or a left or right turn, or the state in which the preceding vehicle flashes the left or right turn signal light, a space into which the own vehicle can advance by accelerating is formed ahead of the own vehicle. Therefore, the accelerator operation by the driver is considered to be intentional acceleration of the own vehicle by the driver. In this case, the vehicle travel intended by the driver can be implemented by the deceleration control being canceled.

In a case in which the road ahead of the own vehicle in the travelling direction is recognized to be a curved road based on the map information and the own vehicle is decelerated by the deceleration control before the curved road, the deceleration control may be canceled under a condition that the own vehicle speed is greater than a target speed for traveling on the curve. The target speed for traveling on a curve may be set based on the curvature of the curved road. Here, in a case in which the deceleration control is performed with the curved road as the deceleration landmark, the map information can be considered erroneous if the own vehicle speed is greater than the target speed for traveling on the curve. The deceleration control can be appropriately canceled.

In a case in which the deceleration control is canceled (forcibly ended) based on the speed return parameter or the other vehicle behavior parameter after the start of deceleration control, the ECU 10 may store and hold the map information that has served as basis for the execution of the deceleration control, that is, the deceleration landmark on the map. That is, the ECU 10 stores and holds the deceleration landmark that is the erroneous information on the map as travel history. Then, the ECU 10 may avoid executing the deceleration control for the deceleration landmark that is the erroneous information when the own vehicle subsequently travels.

The control apparatus and a method thereof described in the present disclosure may be implemented by a dedicated computer that is provided so as to be configured by a processor and a memory, the processor being programmed to provide one or a plurality of functions that are realized by a computer program. Alternatively, the control apparatus and a method thereof described in the present disclosure may be implemented by a dedicated computer that is provided by a processor being configured by a single dedicated hardware logic circuit or more. Still alternatively, the control unit and a method thereof described in the present disclosure may be implemented by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, tangible storage, computer-readable medium that can be read by a computer as instructions performed by the computer.

What is claimed is:

1. A vehicle control apparatus capable of performing deceleration control in which an own vehicle is decelerated based on road conditions ahead of the own vehicle in a travelling direction using map information, the vehicle control apparatus comprising:
an accelerator operation determination unit that determines whether a driver of the own vehicle is operating an accelerator during execution of deceleration control; and
a deceleration control unit that cancels the deceleration control based on travel information of at least either of the own vehicle and another vehicle traveling in a same direction as the own vehicle in a vicinity of the own vehicle, in response to the accelerator operation determination unit determining that the driver is operating the accelerator during execution of the deceleration control.

2. The vehicle control apparatus according to claim 1, comprising:
a parameter acquiring unit that acquires a speed return parameter indicating a state of increase and return of a travel speed of the own vehicle after start of accelerator operation during the execution of deceleration control; wherein
the deceleration control unit uses the speed return parameter as the travel information, and cancels the deceleration control based on a comparison between the speed return parameter and a predetermined threshold.

3. The vehicle control apparatus according to claim 2, wherein:
the vehicle control apparatus is capable of performing constant-speed travel control in which the own vehicle is caused to travel at a predetermined target speed, in addition to the deceleration control;
the parameter acquisition unit acquires the travel speed of the own vehicle as the speed return parameter; and
the deceleration control unit cancels the deceleration control based on the travel speed of the own vehicle being greater than a threshold set based on either of the target speed and a travel speed of a preceding vehicle traveling ahead of the own vehicle, during the execution of deceleration control.

4. The vehicle control apparatus according to claim 2, wherein:
the vehicle control apparatus is capable of performing tracking control in which the own vehicle is caused to travel such as to track a preceding vehicle traveling ahead of the own vehicle while maintaining a predetermined target inter-vehicle distance, in addition to the deceleration control;
the parameter acquisition unit acquires the travel speed of the own vehicle and an inter-vehicle distance between the own vehicle and the preceding vehicle as the speed return parameters; and
the deceleration control unit cancels the deceleration control based on the travel speed of the own vehicle being greater than a threshold set based on a travel speed of the preceding vehicle and the inter-vehicle distance being less than the target inter-vehicle distance during the execution of deceleration control.

5. The vehicle control apparatus according to claim 2, further comprising:
a threshold setting unit that variably sets the threshold based on an acceleration of the own vehicle occurring in accompaniment with the accelerator operation, during the execution of deceleration control.

6. The vehicle control apparatus according to claim 2, wherein:
the parameter acquisition unit acquires an other vehicle behavior parameter indicating behavior counter to the deceleration of the own vehicle for another vehicle traveling in traveling in a position that is ahead, behind, or to left or right of the own vehicle, in addition to the speed return parameter, during the execution of deceleration control;
the deceleration control unit is capable of determining whether to cancel the deceleration control based on the other vehicle behavior parameter; and
the vehicle control apparatus includes
a threshold setting unit that variably sets a threshold such that the deceleration control is easily canceled in response to the deceleration control unit determining that the deceleration control should be canceled based on the other vehicle behavior parameter, compared to when the deceleration control unit not determining that the deceleration control should be canceled based on the other vehicle behavior parameter.

7. The vehicle control apparatus according to claim 2, wherein:
the parameter acquisition unit acquires an other vehicle behavior parameter indicating behavior counter to the deceleration of the own vehicle for another vehicle traveling in traveling in a position that is ahead, behind, or to left or right of the own vehicle, in addition to the speed return parameter, during the execution of deceleration control;
the deceleration control unit is capable of determining whether to cancel the deceleration control based on the other vehicle behavior parameter; and
the vehicle control apparatus includes
a threshold setting unit that variably sets the threshold based on a position of the other vehicle for which the other vehicle behavior parameter is obtained in relation to the own vehicle, that is, whether the other vehicle is ahead, behind, or to the left or right of the own vehicle, or for how many other vehicles the other vehicle behavior parameter is obtained in response to the deceleration control unit determining that the deceleration control should be canceled based on the other vehicle behavior parameter.

8. The vehicle control apparatus according to claim 2, further comprising:
a threshold setting unit that variably sets the threshold based on a type of a deceleration landmark ahead in a travelling direction in the map information.

9. The vehicle control apparatus according to claim 1, further comprising:
a parameter acquisition unit that acquires an other vehicle behavior parameter indicating behavior counter to the deceleration of the own vehicle for another vehicle traveling in traveling in a position that is ahead, behind, or to left or right of the own vehicle, during the execution of deceleration control; and
the deceleration control unit cancels the deceleration control based on the other vehicle behavior parameter as the travel information.

10. The vehicle control apparatus according to claim 9, wherein:
the vehicle control apparatus is capable of performing constant-speed travel control in which the own vehicle is caused to travel at a predetermined target speed, in addition to the deceleration control;
the parameter acquisition unit acquires a travel speed of a preceding vehicle traveling ahead of the own vehicle as the other vehicle behavior parameter; and
the deceleration control unit cancels the deceleration control based on the travel seed of the preceding vehicle being greater than a threshold set based on the target speed.

11. The vehicle control apparatus according to claim 9, wherein:
the parameter acquisition unit acquires preceding vehicle deceleration information indicating whether a preceding vehicle traveling ahead of the own vehicle is in a state of deceleration as the other vehicle behavior parameter; and
the deceleration control unit cancels the deceleration control based on the preceding vehicle deceleration information indicating that the preceding vehicle is not in the state of deceleration while approaching a predetermined distance to a position of a deceleration landmark ahead in the travelling direction in the map information, during the execution of deceleration control.

12. A non-transitory computer-readable storage medium storing therein a program enabling a computer to perform deceleration control in which an own vehicle is decelerated based on road conditions ahead of the own vehicle in a travelling direction using map information, the program causing the computer to perform processes comprising:
an accelerator operation determination process for determining whether a driver of the own vehicle is operating an accelerator during execution of deceleration control; and
a deceleration control process for canceling the deceleration control based on travel information of at least either of the own vehicle and another vehicle traveling in a same direction as the own vehicle in a vicinity of the own vehicle, in response to the accelerator operation determination process determining that the driver is operating the accelerator during the execution of deceleration control.

13. A vehicle control apparatus comprising:
a processor;
a non-transitory computer-readable storage medium; and
a set of computer-executable instructions stored on the computer-readable storage medium that, when read and executed by the processor, cause the processor to implement:
determining whether a driver of the own vehicle is operating an accelerator during execution of deceleration control; and
canceling the deceleration control based on travel information of at least either of the own vehicle and another vehicle traveling in a same direction as the own vehicle in a vicinity of the own vehicle, in response to the accelerator operation determination process determining that the driver is operating the accelerator during the execution of deceleration control.
